(19) United States
(12) Patent Application Publication
(10) Pub. No.: US 2012/0204456 A1
(43) Pub. Date: Aug. 16, 2012

(54) COLLAPSIBLE AND DEPLOYABLE SIGN SYSTEM

(75) Inventors: A. James Dobson, Northville, MI (US); Christopher M. Larsen, Farmington Hills, MI (US)

(73) Assignee: Marketing Displays, Inc., Farmington Hills, MI (US)

(21) Appl. No.: 13/025,409

(22) Filed: Feb. 11, 2011

(51) Int. Cl. G09F 15/00

(52) U.S. Cl. 40/610

(57) ABSTRACT

A collapsible and deployable sign system includes a support tube and a sliding member longitudinally slidable on the support tube. A handle is rotatably connected to the support tube and rotatably linked to the sliding member such that rotation of the handle slidably displaces the sliding member with respect to the support tube. A bracket assembly is fixed to the support tube. At least one scissoring assembly including first and second scissoring links is rotatably connected together by a rotational fastener. The first scissoring link is rotatably connected to the bracket assembly and separately to a corner brace member. The second scissoring link is rotatably connected to the sliding member and separately to the corner brace member. Handle rotation moves the sliding member toward the bracket assembly moving the corner brace member from a stowed condition proximate the support tube away from the support tube to a deployed condition.

### FIELD

The present disclosure relates to sign systems for temporary use along highways or roadways that are deployable from a collapsed or stowed condition to a fully deployed condition.

### BACKGROUND

This section provides background information related to the present disclosure which is not necessarily prior art.

There is a need along public highways and pedestrian walkways for temporary signs to provide notices and information to the public, particularly during major power outages or after storms when electrical power is not locally available to operate stop lights. These temporary signs provide notice and information to the passing public, particularly for those in vehicles, and thus are typically called “traffic control signs”. One common form of a traffic control sign acts as a substitute for a stop light.

Frequently, the need for signs is temporary and it is advantageous to have signs which may be readily and locally assembled and disassembled. At the same time, it is necessary for temporary signs to be durable and resistant to such factors as weather conditions, high winds, wind currents generated by passing vehicles, rain or snow, and rough handling. In order to be portable and collapsible, known temporary signs include a flexible roll-up sign panel connected to a collapsing cross-brace framework, together with a sign stand with foldable and extendable legs. Sign and sign stand combinations of this type are currently available, for example, from Marketing Displays, Inc. Some of these systems are shown, for example, in U.S. Pat. Nos. 4,592,158, 4,593,879, 4,619,220 and 5,340,068. Known temporary sign designs may require duplicate signs when used as a substitution for stop lights, and therefore require multiple such signs for each intersection, increasing the time and cost to provide traffic control signs at multiple intersections.

### SUMMARY

This section provides a general summary of the disclosure, and is not a comprehensive disclosure of its full scope or all of its features.

According to several embodiments, a collapsible and deployable sign system of the present disclosure includes a support tube. A sliding member is longitudinally slidable on the support tube. At least one scissoring assembly includes first and second scissoring links rotatably connected together. The first scissoring link is rotatably connected to the support tube. The second scissoring link is rotatably connected to the sliding member and the corner brace member. The sliding member when displaced acts to move the corner brace member from a stowed condition proximate to the support tube away from the support tube to a deployed condition.

According to other embodiments, a collapsible and deployable sign system includes a support tube and a sliding member longitudinally slidable on the support tube. A handle is rotatably connected to the support tube and rotatably linked to the sliding member such that rotation of the handle slidably displaces the sliding member with respect to the support tube. A bracket assembly is fixed to the support tube. At least one scissoring assembly including first and second scissoring links is rotatably connected together by a rotational fastener. The first scissoring link is rotatably connected to the bracket assembly and separately to a corner brace member. The second scissoring link is rotatably connected to the sliding member and separately to the corner brace member. Rotation of the handle moves the sliding member toward the bracket assembly acting to move the corner brace member from a stowed condition proximate to the support tube away from the support tube to a deployed condition.

According to further embodiments, a collapsible and deployable sign system includes a support tube and a sliding member longitudinally slidable on the support tube. A handle is rotatably connected to the support tube and rotatably linked to the sliding member such that rotation of the handle longitudinally displaces the sliding member with respect to the support tube. A bracket assembly is fixed to the support tube. At least first, second and third scissoring assemblies individually include first and second scissoring links which are rotatably connected together by a rotational fastener. The first scissoring link is rotatably connected to the bracket assembly and a corner brace member. The second scissoring link is rotatably connected to the sliding member and the corner brace member. Rotation of the handle slides the sliding member toward the bracket assembly acting to move the corner brace member from a stowed condition and away from the support tube to a deployed condition. Multiple flexible signs are each connected to proximate ones of the corner brace members.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top front perspective view of a collapsible and deployable sign system of the present disclosure connected to a base member;

FIG. 2 is a top front perspective view of the collapsible and deployable sign system of FIG. 1;

FIG. 3 is a top plan view of the collapsible and deployable sign system of FIG. 1;

FIG. 4 is a cross sectional elevational view taken at section 4 of FIG. 3;

FIG. 5 is a cross sectional elevational view taken at section 5 of FIG. 3;

FIG. 6 is a top front perspective view of the collapsible and deployable sign system of FIG. 1 in a collapsed condition;

FIG. 7 is a top front perspective view of the collapsible and deployable sign system of FIG. 6 in a partially deployed condition;

FIG. 8 is a top front perspective view of the collapsible and deployable sign system of FIG. 6 in a fully deployed condition;

FIG. 9 is a top front perspective view of the collapsible and deployable sign system of FIG. 1 connected to a weighted base member;

FIG. 10 is a top plan view of another embodiment of a collapsible and deployable sign system having 3 flexible signs;

FIG. 11 is a front elevational view of another embodiment of a sign system of the present disclosure in a stowed condition;

FIG. 12 is a front elevational view of the sign system of FIG. 11 in a fully deployed condition;

FIG. 13 is a top front perspective view of another embodiment of a collapsible and deployable sign system having a single scissoring assembly shown in a stowed condition;

FIG. 14 is a top front perspective view of the sign system of FIG. 13 shown in a deployed condition;

FIG. 15 is a top front perspective view of another embodiment of a collapsible and deployable sign system having two scissoring assemblies shown in a stowed condition; and

FIG. 16 is a top front perspective view of the sign system of FIG. 15 shown in a deployed condition.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

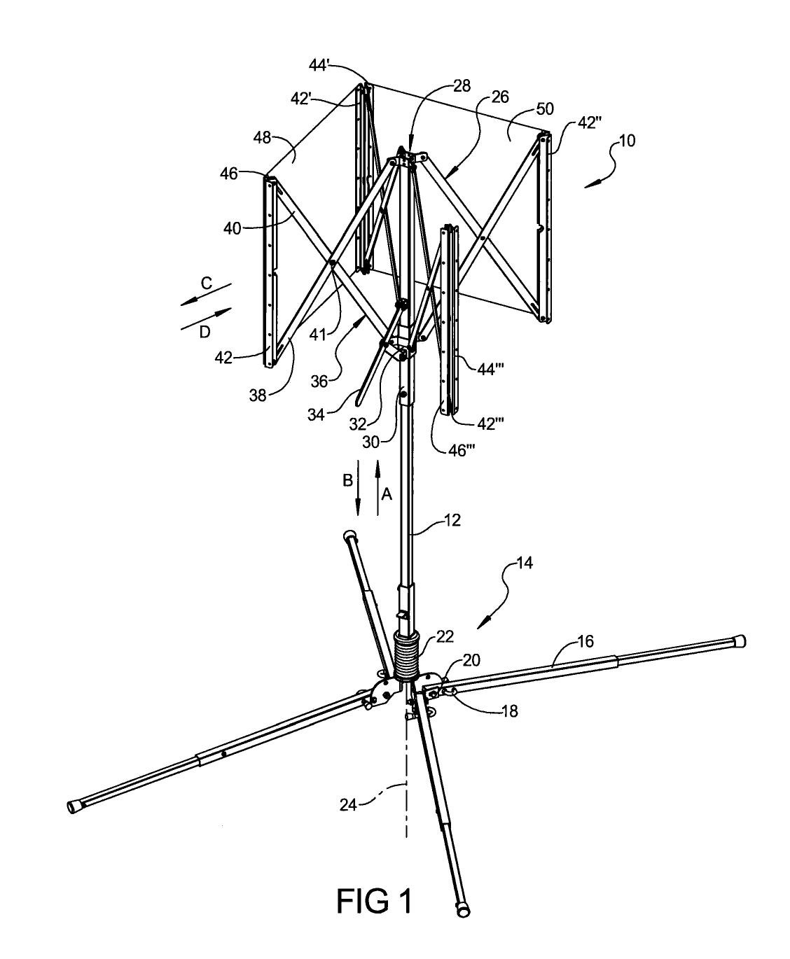

Referring to FIG. 1, a collapsible and deployable sign system 10 is connected to a support post 12 from which sign system 10 is extendable in an upward direction “A” or retractable in a downward direction “B” by adjusting a length of support post 12. Support post 12 is connected to and supported by a base member 14. Base member 14 can include a plurality of legs 16 that can be retracted from the extended and support positions shown by use of one or more releasable fasteners 18. Releasable fasteners 18 when released permit rotation of legs 16 to an orientation substantially parallel to support post 12 by rotation with respect to a rotational fastener 20. According to several embodiments, a biasing member 22 such as a coiled spring can be used to flexibly connect the support post 12 to the base member 14 such that a bending load applied to support post 12, for example from a wind induced load applied to sign system 10, can be accommodated without tipping over base member 14. The sign system 10 then returns to normal (upright) when the wind load is reduced. The use of a single biasing member 22 is preferred when a biasing member is used, such that the load applied to sign system 10 can be accommodated from any direction. The use of single biasing member 22 permits deflection from the nominal upright orientation in any direction with respect to a longitudinal axis 24 of support post 12.

Sign system 10 includes a linkage assembly 26 which operates with a scissoring-action to provide for extension and retraction in each of an extending direction “C” and a retracting direction “D” for individual signs connected to sign system 10. Linkage assembly 26 includes a fixed portion 28 which is fixedly connected at an upper end of a support tube 30. Support tube 30 is slidably disposed onto and then coupled to support post 12. Positioned below fixed portion 28 is a sliding member 32 which is slidably disposed with respect to support tube 30. Sliding member 32 is capable of moving in either the upward direction “A” or oppositely in the downward direction “B” with respect to support tube 30.

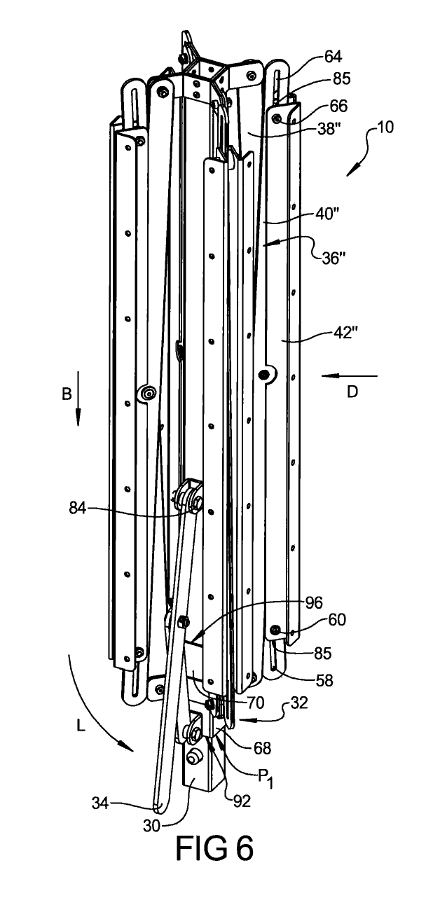

According to several embodiments, linkage assembly 26 includes a handle 34 rotatably connected to support tube 30 and rotatably linked to sliding member 32. As viewed in FIG. 1, an upward directed rotation of handle 34 acts to move sliding member 32 in the upward direction “A” to deploy sign system 10 to the fully deployed condition shown. An opposite or downward rotation of handle 34 displaces sliding member 32 in the downward direction “B” to return sign system 10 to a retracted or stowed condition shown and described in reference to FIG. 6.

According to several embodiments, linkage assembly 26 also includes a plurality of scissoring assemblies 36. Each of the scissoring assemblies 36 includes a first scissoring link 38 rotatably connected to a second scissoring link 40 using a rotational fastener 41 located approximately at a mid span position of both first and second scissoring links 38, 40. A corner brace member 42 is connected at free ends of both the first and second scissoring links 38, 40 for each of the scissoring assemblies 36. In the exemplary embodiment shown, four (4) scissoring assemblies 36 are used, therefore four (4) corner brace members 42, 42′, 42″, 42″′ are provided. Each of the corner brace members 42 includes a first sign connector 44 and a second sign connector 46. According to the embodiment shown having four corner brace members 42, the first and second sign connectors 44, 46 of each corner brace member 42 are oriented approximately 90 degrees with respect to each other. This angle can be varied if less than four or more than four corner brace members 42 are used.

According to several embodiments, the sliding member 32 has a quantity of outer faces or sides that directly correspond to a quantity of outer faces or sides of support tube 30. In the exemplary embodiment of FIG. 1, sliding member 32 has four sides, each positioned in sliding contact with one of the four sides of support tube 30. By matching the quantity of sides between sliding member 32 and support tube 30, the geometry of sliding member 32 is matched to the geometry of support tube 30 and axial rotation of either member when a wind load is applied to sign system 10 is thereby prevented. In the exemplary embodiment of FIG. 1, sliding member 32 and support tube 30 both have four sides, however this quantity is not limiting. In other embodiments, the geometry of both sliding member 32 and support tube 30 can be oval, cross-shaped, triangular, square, rectangular, or five or more sided.

A flexible sign, such as first flexible sign 48, is connected between two proximate ones of the corner brace members 42. For example, first flexible sign 48 is connected to second sign connector 46 of corner brace member 42 and to first sign connector 44′ of corner brace member 42′. A second flexible sign 50 is similarly connected between corner brace members 42′ and 42″, respectively. Additional flexible signs are not shown in this view for clarity. Each of the flexible signs, such as first and second flexible signs 48, 50, can be made from a flexible but substantially un-stretchable material, such as a polymeric material, which can unfold from a stowed condition and extend to the taught, fully deployed condition shown in FIG. 1.

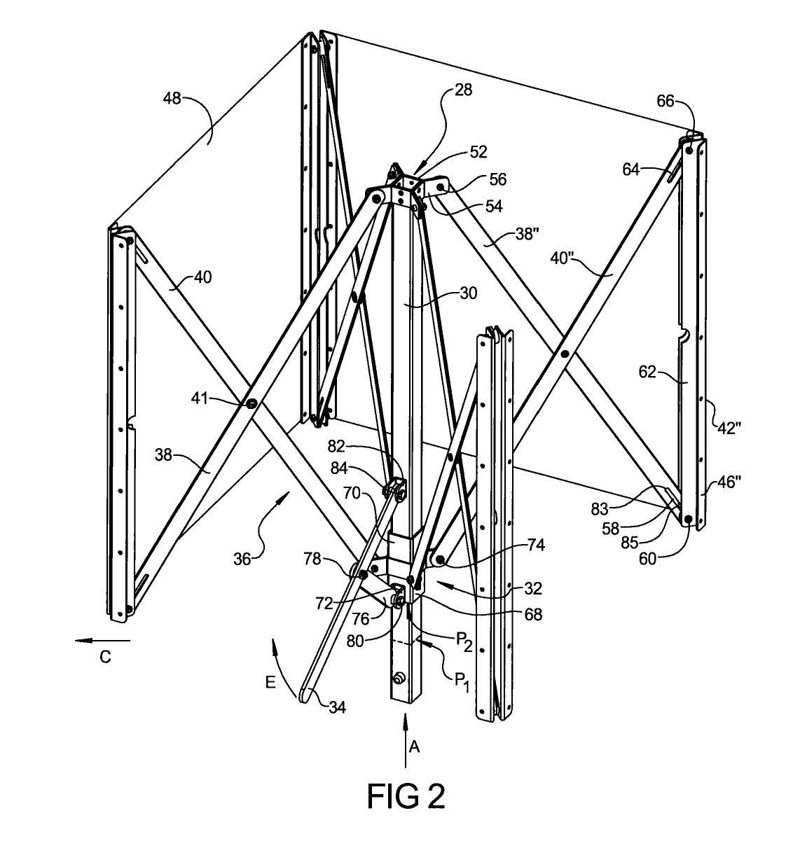

Referring to FIG. 2, fixed portion 28 includes a bracket assembly 52 which is fixed to support tube 30 at an upper end thereof. Bracket assembly 52 includes a plurality of bracket arms 54 extending at right angles to the orientation of support tube 30. The quantity of bracket arms 54 used varies directly with the quantity of scissoring assemblies 36. Each of the first scissoring links 38 is rotatably connected to one of the bracket arms 54 using a rotational fastener 56. An opposite end of each of the first scissoring links 38 is provided with a first elongated slot 58. A first slot fastener 60 is received in first elongated slot 58 and is rotatably connected to a rigid leg 62 of each of the first and second sign connectors 44, 46 of the corner brace members 42. Similarly, a second elongated slot 64 is provided at an outward end of each of the second scissoring links 40, and a second slot fastener is received in the second elongated slot 64 and is rotatably connected to an opposite end of rigid leg 62 with respect to first slot fastener 60. Each of the first and second slot fasteners 60, 66 extends through the rigid leg 62 of both first and second sign connectors 44, 46 of each corner brace member 42.

Sliding member 32 can include a first sliding member portion 68 and a second sliding member portion 70 spatially separated from first sliding member portion 68. One or more connecting members 72 can be used to connect first sliding member portion 68 to second sliding member portion 70. Connecting members 72 also provide for rotational connection of the individual second scissoring links 40, using second scissoring link rotational fasteners 74. One of the connecting members 72 is further used to rotatably connect a handle connecting link 76. A handle/link rotational fastener 78 is used to rotatably connect handle 34 to handle connecting link 76. A link rotational fastener 80 is used to rotatably connect handle connecting link 76 to connecting member 72. To reach the fully deployed condition of sign system 10 shown, handle 34 is rotated with respect to a handle deployment arc of rotation “E” to a maximum rotated position, which vertically displaces sliding member 32 from a stowed position P₁ to a deployed position P₂.

The upward sliding motion of sliding member 32 causes each of the scissoring assemblies 36 to extend outwardly in the extending direction “C”. This outward extension of the scissoring assemblies 36 is caused by a reduction in a spacing or distance between second scissoring link rotational fasteners 74 and rotational fasteners 56. One end of handle 34 is rotatably connected to support tube 30 using a handle connecting bracket 82 fixed to support tube 30 and a handle rotational fastener 84 which rotatably connects handle 34 to handle connecting bracket 82. Rotation of handle 34 in the handle deployment arc of rotation “E” provides a component of vertical displacement via handle connecting link 76 to pull sliding member 32 in the upward direction “A” and toward handle connecting bracket 82.

As each of the scissoring assemblies 36 extends outwardly in the extending direction “C”, each first slot fastener 60 and each second slot fastener 66 moves outwardly toward an outward slot end 83 of the respective first and second elongated slots 58, 64. The use of first and second elongated slots 58, 64 accommodates a difference in length between both the first and second scissoring links 38, 40 and the corner brace members 42. According to several embodiments, a length of first and second scissoring links 38, 40 is greater than a length of the corner brace members 42 to provide for the horizontal displacement distance between the corner brace members 42 and support tube 30 when the corner brace members 42 are moved to the deployed condition. When stowed, the greater length of first and second scissoring links 38, 40 compared to the corner brace members 42 is accommodated by motion of the first and second slot fasteners 60, 66 toward an inward slot end 85 of the first and second elongated slots 58, 64.

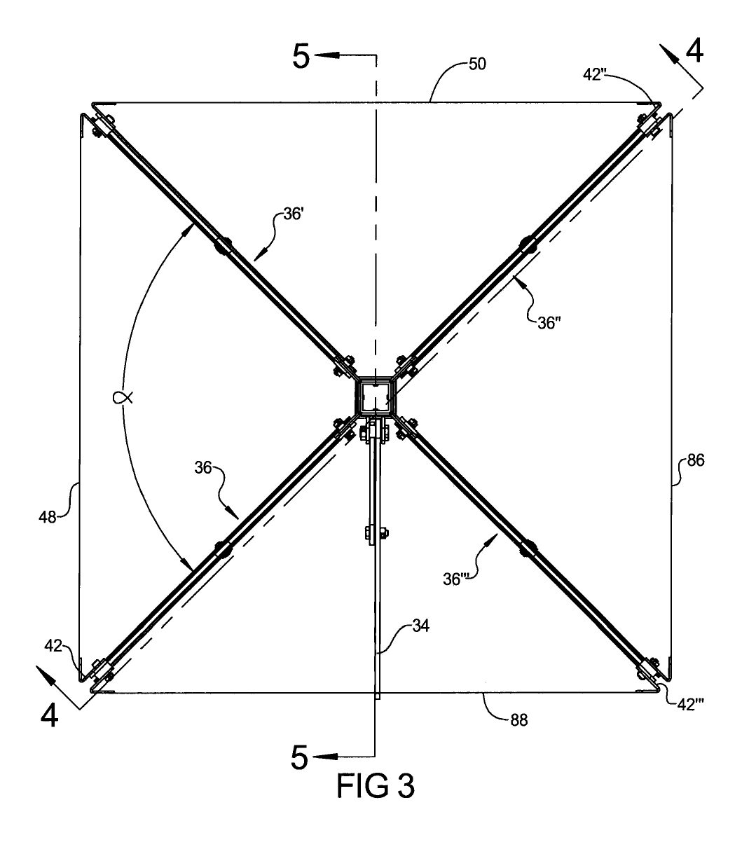

Referring to FIG. 3, handle 34 can be provided in any quadrant selected by the manufacturer. In the example shown, handle 34 is positioned equidistantly between scissoring assembly 36 and scissoring assembly 36″. The quantity of individual flexible signs that are used by sign systems 10 will vary depending on the quantity of corner brace members 42 that are used. For example, the use of four corner brace members 42 results in a substantially square-shaped sign system 10 in the fully deployed condition shown. In addition to first and second flexible signs 48, 50, sign system 10 having four corner brace members 42 further includes a third flexible sign 86 connected to each of corner brace members 42″ and 42′″, and a fourth flexible sign 88 connected to each of corner brace members 42′″ and 42. An orientation angle α defined between proximate ones of the scissoring assemblies 36 is directly dependent on a quantity of corner brace members 42 that are used. In the 4-sided embodiments shown, orientation angle α is approximately 90 degrees. When deployed, each of the flexible signs are pulled taught and it is desirable that each flexible sign defines a substantially planar surface in the deployed condition to render information printed or shown on an outward facing surface of the flexible signs visible.

In other embodiments of sign system 10 (not shown), quantities of three, five, or more corner brace members 42 can be used. This can result, for example, in a triangle-shaped sign system 10 having three flexible signs, or a five-sided sign system 10, having five flexible signs. According to still further embodiments, not all of the locations available for supporting flexible signs are used. For example, an embodiment of sign system 10 can be deployed having only first flexible sign 48 and/or opposed third flexible sign 86. This type of configuration can be used where the individual flexible signs may only be visible on predetermined sides of sign system 10.

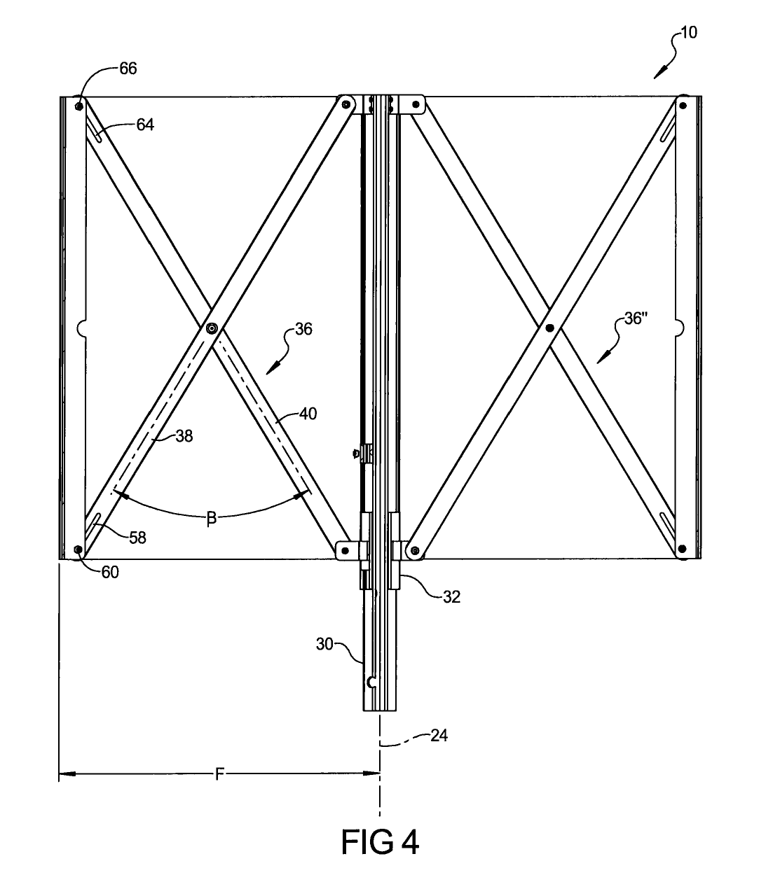

Referring to FIG. 4, a maximum deployed spacing “F” can be varied according to several options. These options include changing a width of the individual flexible signs, changing a total vertical displacement of sliding member 32, and/or changing a length of the individual first and second scissoring links 38, 40. A link separation angle β can therefore be varied based on the options provided above for different embodiments of sign system 10. As the individual lengths of first and second scissoring links 38, 40 are varied between various embodiments, a length of the individual first and second elongated slots 58, 64 can be also be varied.

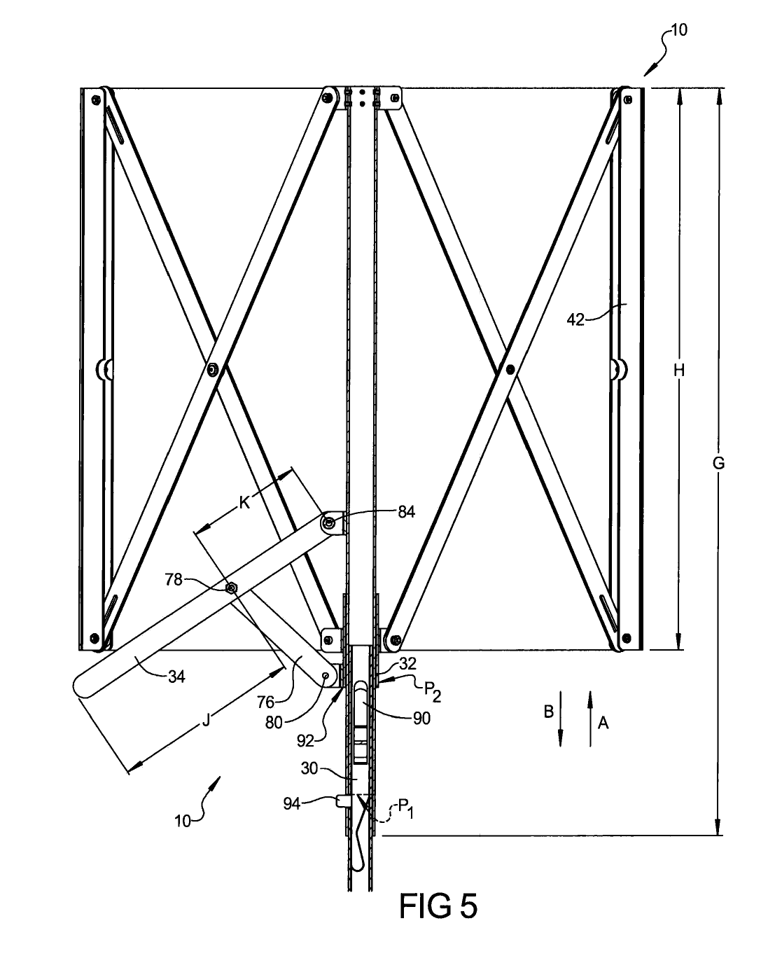

Referring to FIG. 5, mechanical advantage is gained in the design of handle 34 by providing a handle free length “J” from a free end of handle 34 to the handle/link rotational fastener 78 which is greater than a handle connection length “K” between handle/link rotational fastener 78 and handle rotational fastener 84. A length of handle connecting link 76 can also be varied to control a total throw or arc of rotation of handle 34. In addition, a distance between handle rotational fastener 84 and link rotational fastener 80 can be varied to control a total degree of rotation of handle 34.

A total sign system height “G” can be varied by controlling the length of support tube 30, in addition to varying a sign height “H” of the various flexible signs, and/or a length of corner brace members 42. According to several embodiments, the deployed position P₂ can be established by the use of a first bias detent member 90 having a biasing member located substantially within support tube 30 and is biased such that a portion of the first bias detent member 90 extends outwardly from support tube 30. As sliding member 32 is moved in the upward direction “A” to deploy sign system 10, first bias detent member 90 is depressed inwardly into support tube 30 until a bottom edge 92 of sliding member 32 passes upwardly of first bias detent member 90. At this time, first bias detent member 90 slides outwardly with respect to support tube 30 and provides a contact point with support edge 92 defining the deployed position P₂. To return sign system 10 to the stowed condition, first bias detent member 90 is depressed into support tube 30, providing clearance at edge 92 such that sliding member 32 can return in the downward direction “B” to the stowed position P₁. According to further embodiments, a second bias detent member 94 can be provided at the stowed position P₁ to provide a positive stop for downward travel of sliding member 32 to establish stowed position P₁. Second bias detent member 94 can also be replaced with a fastener or similar device which permanently extends outwardly with respect to support tube 30 to establish stowed position P₁.

Referring to FIG. 6, sign system 10 is shown in a stowed condition reached by rotating handle 34 in a handle retraction arc of rotation “L” to return sign system 10 to a stowed position P₁ by displacing sliding member 32 in the downward direction “B”. The flexible signs are not shown for clarity. As sliding member 32 moves in the downward direction “B”, each of the scissoring assemblies 36 retracts or collapses. First slot fastener 60 moves toward inward slot end 85 of first elongated slot 58 and second slot fastener 66 moves toward inward slot end 85 of second elongated slot 64. A length of handle 34 can be selected to provide at least a portion of handle 34 which is exposed in the stowed condition. This provides manual access to handle 34 without reaching up into the area of the folded flexible signs.

With continuing reference to both FIGS. 5 and 6, the stowed position P₁ of sign system 10 can also be releasably retained if an upper edge 96 of second sliding member portion 70 is positioned below first bias detent member 90 such that first bias detent member 90 extends outwardly from support tube 30 and contacts upper edge 96 to prevent deployment of sign system 10 until first bias detent member 90 is once again depressed into support tube 30, providing clearance for sliding motion of sliding member 32.

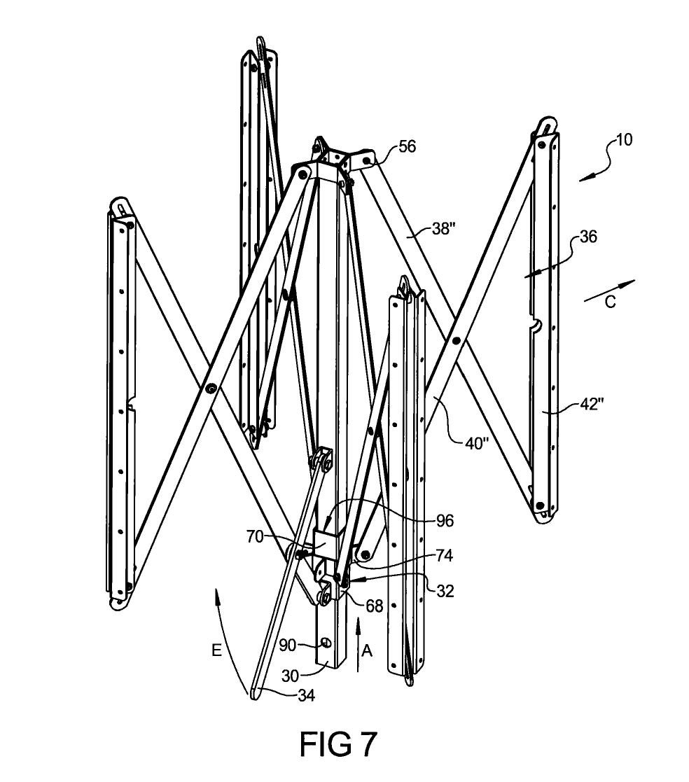

Referring to FIG. 7, sign system 10 is shown during deployment following initial rotation of handle 34 in the handle deployment arc of rotation “E”. At this stage, upper edge 96 of second sliding member portion 70 is approaching the extending portion of first bias detent member 90 which is biased to extend outwardly with respect to support tube 30. At this time, to permit further sliding motion of sliding member 32 in the upward direction “A”, first bias detent member 90 is manually depressed to provide clearance for upper edge 96 to pass the position of the depressed first bias detent member 90. Continued sliding motion of sliding member 32 in the upward direction “A” extends each of the corner brace members 42 in the extending direction “C” by extension of each of the scissoring assemblies 36.

Referring to FIG. 8, at the fully deployed condition of sign system 10, each of the corner brace members 42, 42′, 42″, 42′″ is fully extended in corresponding extending directions “C” with respect to support tube 30 and sliding member 32 is positioned such that first sliding member portion 68 is above and contacts first bias detent member 90. The outward extension of each of the corner brace members 42 laterally extends and stiffens the plurality of flexible signs (not shown in this view). A manual upward force in the handle deployment arc of rotation “E” applied to handle 34 is maintained until first bias detent member 90 springs outwardly following clearance with respect to first sliding member portion 68. The tendency of sign system 10 to return by gravity from the fully deployed to the retracted, stowed condition is overcome by contact with first bias detent member 90.

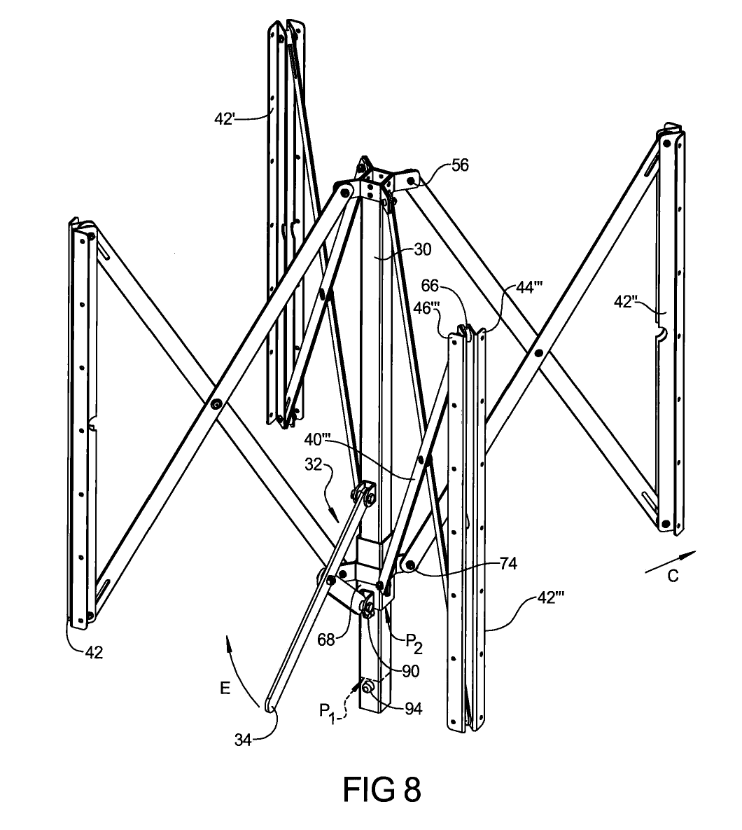

Referring to FIG. 9, sign system 10 can be supported by multiple support members, including a weighted storage member 98 such as a barrel containing water or other material to provide resistance to overturning from a wind load applied to sign system 10. Support post 12 can also be clamped, fastened, or otherwise connected to other structure, such as a vehicle bumper, a power generator, or other weighted component present at a construction or emergency site.

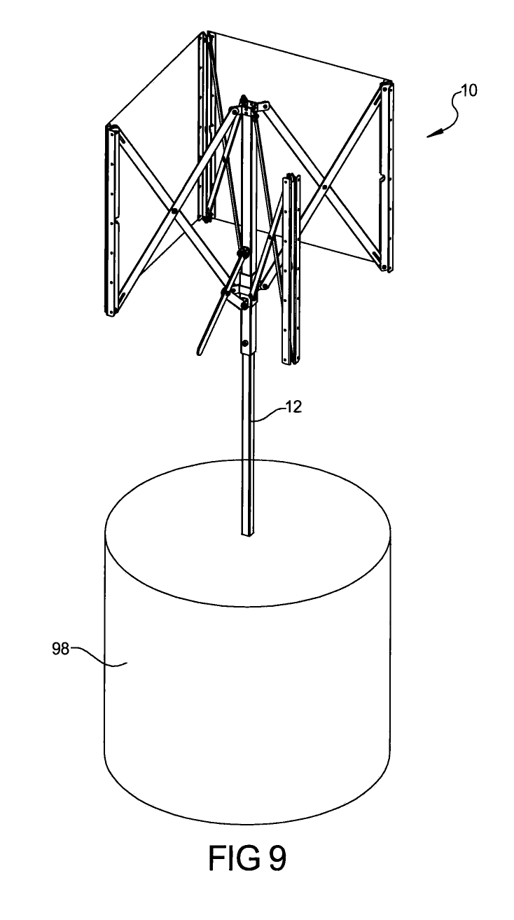

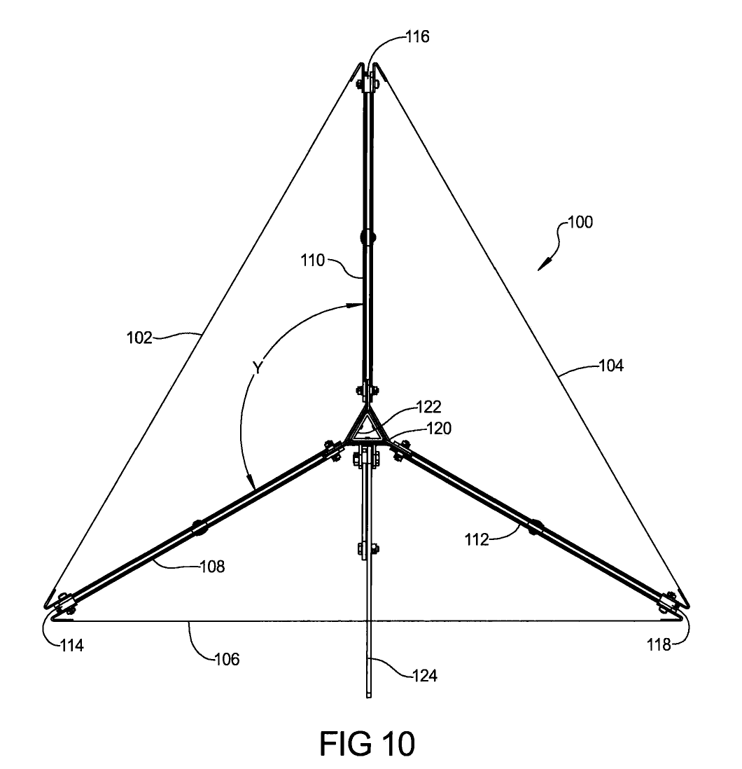

Referring to FIG. 10 and again to FIGS. 1 and 3, a sign system 100 is a 3-sign system having first, second and third flexible signs 102, 104, 106 which are positioned in the deployed condition shown by extension of first, second and third scissoring assemblies 108, 110, 112 which are constructed and operate similar to scissoring assemblies 36. First, second and third corner brace members 114, 116, 118 are modified from corner brace members 42 to accommodate an orientation angle gamma (γ) which is approximately 120 degrees and therefore larger than orientation angle α of sign system 10. A sliding member 120 is modified from sliding member 32 to form a generally triangular shape corresponding to the 3-sign system of sign system 100. A support tube 122 can also have a triangle shape to prevent axial rotation of sign system 100, however support tube 122 can also have different geometric shapes which also prevent axial rotation of sliding member 120. A handle 124 is linked to sliding member 120 and rotatably connected to support tube 122 similar to the connection of handle 34. Similar to sign system 10, sign system 100 provides a view of at least one of first, second and/or third flexible signs 102, 104, 106 by an observer positioned at any horizontal position within 360 degrees of support tube 122.

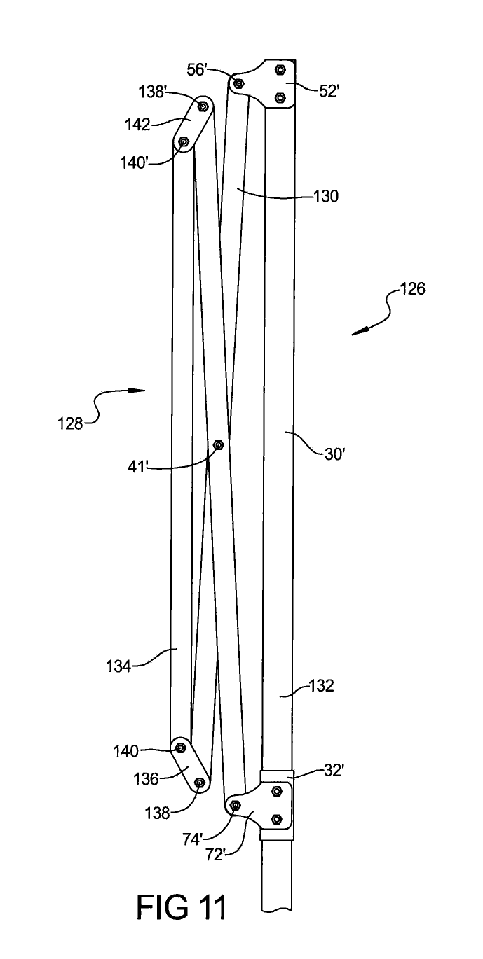

Referring to FIG. 11 and again to FIGS. 2 and 10, a sign system 126 is modified to include a scissoring assembly 128 which eliminates the elongated slots 52, 64 of scissoring assemblies 36, 108, 110 and 112. Sign system 126 includes first and second scissoring links 130, 132. First scissoring link 130 is rotatably connected to bracket assembly 52′ using a rotatational fastener 56′. Bracket assembly 52′ is fixed to an upper end of support tube 30′. Second scissoring link 132 is rotatably connected to connecting member 72′ using a rotatational fastener 74′. Connecting member 72′ is fixed to sliding portion 32′ which is slidably disposed on support tube 30′.

First and second scissoring links 130, 132 are rotatably connected using rotational fastener 41′. First scissoring link 130 is connected to a corner brace member 134 using a first connecting link 136, and connecting link rotational fasteners 138, 140. Second scissoring link 132 is similarly rotatably connected to corner brace member 134 using a second connecting link 142, and connecting link rotational fasteners 138′, 140′. First and second connecting links 136, 142 permit the stowed condition of sign system 126 by making up for a shorter length of corner brace member 134 compared to first and second scissoring links 132, 134. Rotational fastener 41′ is not centrally located in first and second scissoring links 130, 132, but is positioned closer to first and second connecting links 136, 142 allowing a distance between sliding member 32′ and bracket assembly 52′ to exceed a length of corner brace member 134.

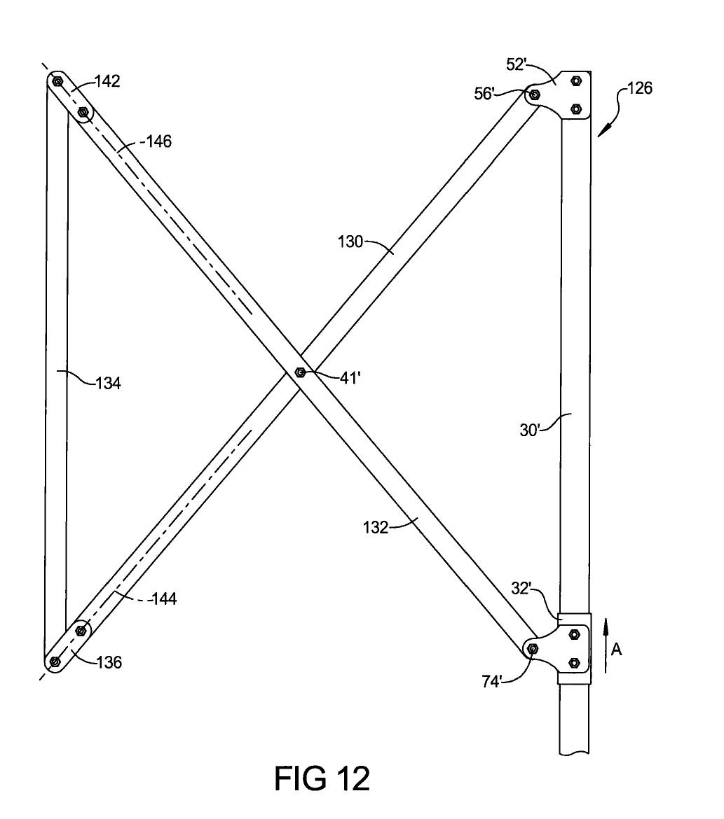

Referring to FIG. 12 and again to FIG. 11, scissoring assembly 128 is moved away from its stowed condition to a fully deployed condition by moving sliding portion 32′ in the upward direction “A” such that a distance between sliding portion 32′ and bracket assembly 52′ decreases to approximately equal the length of corner brace member 134. At the fully deployed condition of scissoring assembly 128, first connecting link 136 is co-axially aligned with a longitudinal axis 144 of first scissoring link 130, and second connecting link 142 is co-axially aligned with a longitudinal axis 146 of first scissoring link 132.

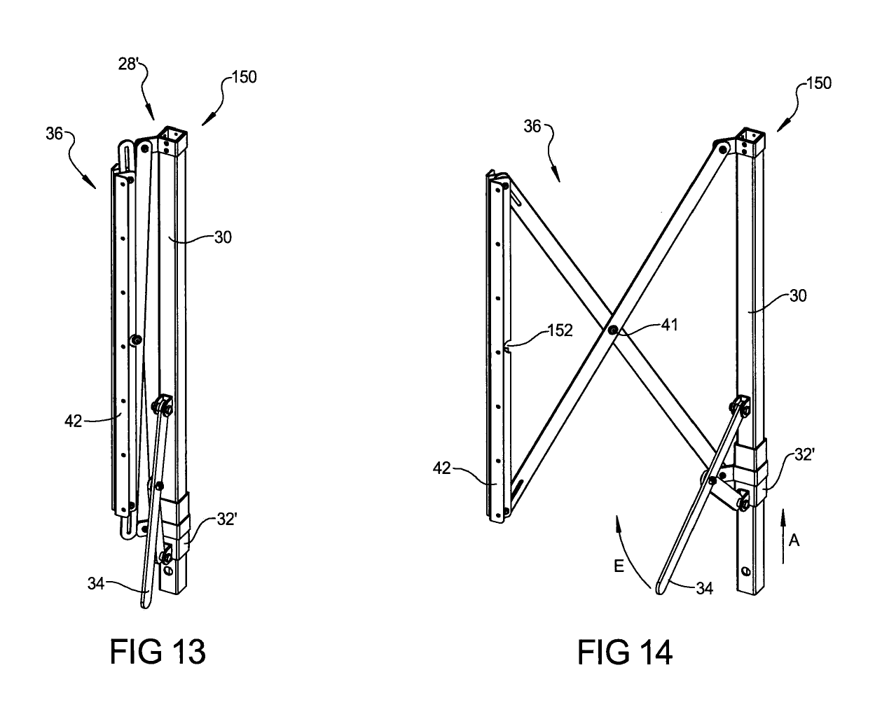

Referring to FIG. 13, a sign system 150 includes only a single scissoring assembly 36 which in a stowed condition shown is fully collapsed against support tube 30 with a sliding portion 32′ at a lowest position and located at a farthest distance away from a fixed portion 28′. Sliding portion 32′ and fixed portion 28′ are modified for attachment of only the single scissoring assembly 36. Handle 34 is substantially the same as in previous embodiments and is connected to slidably displace sliding portion 32′. The single corner brace member 42 is located proximate to support tube 30 in the stowed condition.

Referring to FIG. 14 and again to FIG. 13, in a deployed condition of sign system 150 handle 34 is rotated in the handle deployment arc of rotation “E” as previously described herein to move sliding portion 32′ in the upward direction “A” which extends corner brace member 42 away from support tube 30. Corner brace member 42 can include a clearance slot or partial aperture 152 which partially receives rotational fastener 41 in the stowed condition, allowing corner brace member to more closely approach support tube 30 during stowage.

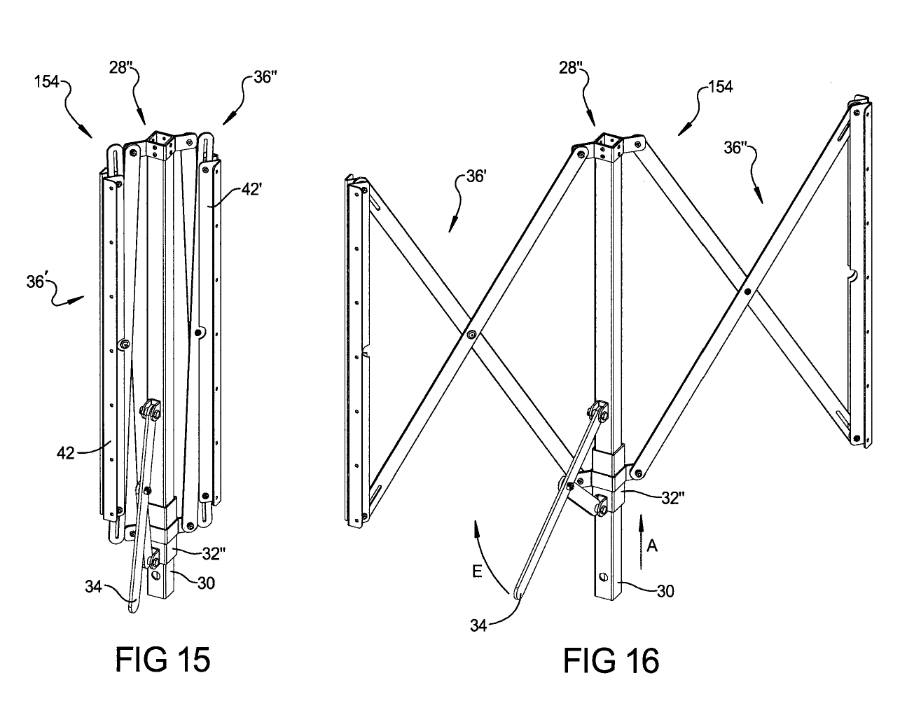

Referring to FIG. 15, a sign system 154 includes only first and second scissoring assemblies 36′, 36″ which in a stowed condition shown are fully collapsed against support tube 30 with a sliding portion 32″ at a lowest position and located at a farthest distance away from a fixed portion 28″. Sliding portion 32″ and fixed portion 28″ are modified for attachment of only first and second scissoring assemblies 36′, 36″. Handle 34 is substantially the same as in previous embodiments and is connected to slidably displace sliding portion 32″. First and second corner brace members 42, 42′ are located proximate to support tube 30 in the stowed condition.

Referring to FIG. 16 and again to FIG. 15, in a deployed condition of sign system 154 handle 34 is rotated in the handle deployment arc of rotation “E” as previously described herein. This handle rotation moves sliding portion 32″ in the upward direction “A” and toward fixed portion 28″ which extends first and second corner brace members 42, 42′ away from support tube 30.

Sign systems 10, 100, 126, 150 and 156 of the present disclosure offer several advantages. By using equally sized scissoring assemblies 36 or 108, 110, 112, a single upward motion of handle 34, 124 will equidistantly and fully deploy each of the flexible signs. For sign systems 10, 100 and 126 of the present disclosure having at least 3 scissoring assemblies 36 or 108, 110, 112, a full 360 degree range of visibility is provided to at least one the signs. Use of scissoring assemblies 36 or 108, 110, 112 also permits complete collapse of sign systems 10, 100 for ease of transportation, to minimize wind load when deployment is not required, or during conditions of limited or no visibility of the signs, such as at night or when construction workers or emergency personnel are not present.

With continued reference to FIGS. 1, 13 and 15, sign systems 10, 100, 150, and 156 of the present disclosure can include a minimum of one, or two, three, four or more than four scissoring assemblies 36, 108, 110, 112, 152, 158. The use of a single scissoring assembly 36 may be of particular benefit when rigid, planar faced signs are used, as these signs can be connected after deployment of the scissoring assembly. The use of at least three scissoring assemblies 36 or 108, 110, 112, supporting 3 flexible signs and creating a triangular shaped assembly, will provide 360 degree visibility, making at least one of the signs visible to an observer located at any horizontal viewing position about a 360 degree range with respect to support tube 30, 122.

A four-sided sign system such as shown in FIG. 3 is particularly advantageous when the sign indicia represent “stop” signs. A single sign system 10 can be used in an intersection having one of its four “stop” signs directed toward each incoming lane of traffic, thereby limiting a quantity of sign systems required for a 4-way intersection to a single sign system. Yield or other warning sign indicia can also be provided. The time required to supply temporary signs at multiple intersections during a power outage is thereby minimized.

According to further embodiments and referring again to FIGS. 2 and 5, handle 34, its connecting member 72 and connecting link 76 can be eliminated and the operator can manually grasp sliding member 32 to deploy or retract sign system 10. In these embodiments, sliding member 32 can be modified in shape or geometry to provide for an improved grip by the operator, including increasing its length, providing a circular or oval sliding member, or the like.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A collapsible and deployable sign system, comprising:
a support tube;
a sliding member longitudinally slidable with respect to the support tube; and
at least one scissoring assembly including first and second scissoring links rotatably connected together, the first scissoring link also rotatably connected to the support tube and to a corner brace member, the second scissoring link also rotatably connected to the sliding member and the corner brace member, the sliding member when displaced acting to move the corner brace member from a stowed condition proximate to the support tube away from the support tube to a deployed condition.

2. The collapsible and deployable sign system of claim 1, wherein the at least one scissoring assembly includes at least first, second and third scissoring assemblies, and the sliding member is triangle shaped.

3. The collapsible and deployable sign system of claim 2, further including a first sign connected to the corner brace members of the first and second scissoring assemblies, a second sign connected to the corner brace members of the second and third scissoring assemblies, and a third sign connected to the corner brace members of the third and first scissoring assemblies, each of the first second and third signs fully extended and taught in the deployed condition, wherein at least one of the first, second and third signs is visible to an observer located at any position about a 360 degree arc with respect to the support tube.

4. The collapsible and deployable sign system of claim 1, wherein the corner brace member includes first and second sign connectors and a rigid leg, and a sign is connected to individual ones of the first or second sign connectors.

5. The collapsible and deployable sign system of claim 1, further including a handle rotatably connected to the support tube and rotatably linked to the sliding member such that rotation of the handle slidably displaces the sliding member with respect to the support tube.

6. The collapsible and deployable sign system of claim 1, further including a bracket assembly directly fixed to the support tube having the first scissoring link rotatably connected to the bracket assembly by a rotational fastener extending through the first scissoring link and the bracket assembly.

7. The collapsible and deployable sign system of claim 1, wherein the at least one scissoring assembly includes at least first, second, third and fourth scissoring assemblies and the sliding member is rectangle shaped.

8. The collapsible and deployable sign system of claim 7, further including a first flexible sign connected to the corner brace members of the first and second scissoring assemblies, a second flexible sign connected to the corner brace members of the second and third scissoring assemblies, a third flexible sign connected to the corner brace members of the third and fourth scissoring assemblies, and a fourth flexible sign connected to the corner brace members of the fourth and first scissoring assemblies, each of the first, second, third and fourth flexible signs fully extended and taught in the deployed condition, wherein at least one of the first, second, third or fourth flexile signs is visible to an observer located at any position about a 360 degree arc with respect to the support tube.

9. The collapsible and deployable sign system of claim 1, further including:
a first connecting link rotatably connecting the first scissoring link to the corner brace member; and
a second connecting link rotatably connecting the second scissoring link to the corner brace member;
wherein the first connecting link is co-axially aligned with a longitudinal axis of the first scissoring link in the deployed condition, and the second connecting link is co-axially aligned with a longitudinal axis of the second scissoring link in the deployed condition.

10. A collapsible and deployable sign system, comprising:
a support tube;
a sliding member longitudinally slidable on the support tube;
a handle rotatably connected to the support tube and rotatably linked to the sliding member such that rotation of the handle slidably displaces the sliding member with respect to the support tube;
a bracket assembly fixed to the support tube; and
at least one scissoring assembly including first and second scissoring links rotatably connected together by a rotational fastener, the first scissoring link further rotatably connected to the bracket assembly and separately to a corner brace member, and the second scissoring link further rotatably connected to the sliding member and separately to the corner brace member, rotation of the handle operating to move the sliding member toward the bracket assembly acting to move the corner brace member from a stowed condition proximate to the support tube away from the support tube to a deployed condition.

11. The collapsible and deployable sign system of claim 10, wherein the corner brace member includes:
a first sign connector angularly disposed with respect to a first rigid leg; and
a second sign connector angularly disposed with respect to a second rigid leg.

12. The collapsible and deployable sign system of claim 11, wherein a first rotatable fastener is rotatably connected to the first scissoring link and both first and second rigid legs, and a second rotatable fastener is rotatably connected to the second scissoring link and both first and second rigid legs.

13. The collapsible and deployable sign system of claim 12, wherein each of the first and second scissoring links include an elongated slot with the first rotatable fastener is slidably received in the elongated slot of the first scissoring link and the second rotatable fastener is slidably received in the elongated slot of the second scissoring link.

14. The collapsible and deployable sign system of claim 10, wherein a quantity of sides of the sliding member is equal to a quantity of sides of the support tube thereby preventing axial rotation of the sliding member with respect to the support tube.

15. The collapsible and deployable sign system of claim 10, wherein a geometry of the sliding member matches a geometry of the support tube thereby preventing axial rotation of the sliding member with respect to the support tube.

16. The collapsible and deployable sign system of claim 10, further including a handle connecting link rotatably connected to the handle and rotatably connected to a connecting member fixed to the sliding member, wherein a first distance between a free end of the handle to a rotational connector joining the handle to the handle connecting link is greater than a second distance between the rotational connector a and a second rotational connector rotatably connecting the handle to the support tube.

17. A collapsible and deployable sign system, comprising:
a support tube;
a sliding member longitudinally slidable on the support tube;
a handle rotatably connected to the support tube and rotatably linked to the sliding member such that rotation of the handle longitudinally displaces the sliding member with respect to the support tube;
a bracket assembly fixed to the support tube;
at least first, second and third scissoring assemblies individually including first and second scissoring links rotatably connected together by a rotational fastener, the first scissoring link further rotatably connected to the bracket assembly and a corner brace member, and the second scissoring link further rotatably connected to the sliding member and the corner brace member, rotation of the handle operating to slide the sliding member toward the bracket assembly acting to move the corner brace member from a stowed condition and away from the support tube to a deployed condition; and
multiple flexible signs, each connected to proximate ones of the corner brace members.

18. The collapsible and deployable sign system of claim 17, further including a biased detent member normally biased to an extended position partially extending outwardly from the support tube, the biased detent member extending outwardly from the support tube contacting an edge of the sliding member to releasably retain the sliding member at a position with respect to the support tube corresponding to the deployed condition.

19. The collapsible and deployable sign system of claim 17, wherein the flexible signs are folded in the stowed condition.

20. The collapsible and deployable sign system of claim 17, wherein the flexible signs are individually pulled taught thereby defining individual planar surfaces in the deployed condition.

21. The collapsible and deployable sign system of claim 17, wherein an orientation angle between any two proximate ones of the scissoring assemblies is directly related to a quantity of the corner brace members.
